(19) United States
(12) Patent Application Publication
(10) Pub. No.: US 2005/0246228 A1
(43) Pub. Date: Nov. 3, 2005

(54) On-hold sponsorship and advertising system and method

(76) Inventor: John Billingsley, Dallas, TX (US)

Correspondence Address: R. Blake Johnston;PIPER RUDNICK LLP, P.O. Box 64807, Chicago, IL, 60664-0807, US

(21) Appl. No.: 10/836,292

(22) Filed: Apr. 30, 2004

(51) Int. Cl. G06F 17/60; H04M 3/00; H04M 5/00

(52) U.S. Cl. 705/14

(57) ABSTRACT

A message player is connected to the music on-hold input of a telephone system of a non-profit or community organization. The message player is provided by a service provider that also sells advertising space on the player to businesses. Information regarding the organization's activities as well as advertisements for the businesses are loaded by the service provider onto the message player. The service provider receives advertising fees from the businesses and distributes a portion of these fees to the organization. The organization may also sell advertising space on the message player to businesses and obtain a greater portion of the advertising fees. Updated messages may be downloaded into the player remotely from the service provider.

### BACKGROUND OF THE INVENTION

The invention relates generally to on-hold programming for telephone systems and, more particularly, to an on-hold sponsorship and advertising system and method.

When an organization or business receives telephone calls, the caller is often placed on hold awaiting further disposition. Before on-hold systems were developed, callers were forced to listen to silence while they were on hold. Callers often became bored or frustrated if they were kept on hold for an extended period of time. As a result, callers would often hang up. On-hold systems were developed to address this issue. With on-hold systems, pre-recorded programming, such as messages, music or advertising, are played as a caller remains on hold. Messages and advertising may include, for example, sales announcements or store hours.

Because of the popularity of on-hold programming, most business telephone systems available today have been designed to include on-hold capabilities. More specifically, the telephone systems often feature an on-hold input jack, usually referred to as a Music On-Hold (MOH) port or input. A player for playing the messages, music or advertising is connected to the telephone system via the MOH input. Many early players featured endless loop cassette tapes so that callers would hear the programming recorded on the tape repetitively.

As on-hold time has become recognized by organizations and businesses as a valuable resource, more sophisticated and creative on-hold systems and programming have been developed. For example, U.S. Pat. No. 5,946,378 to Farfan, U.S. Pat. No. 6,178,240 to Walker et al. and U.S. Pat. No. 6,400,804 to Bilder illustrate on-hold systems that permit callers placed on hold to interactively select from a number of options with which to be entertained or informed. U.S. Pat. No. 6,212,262 to Kamel illustrates an on-hold system that permits a caller placed on hold to purchase items. Published U.S. patent application Publication No. US 2003/0112927 (U.S. application Ser. No. 10/022,163) to Brown et al. discloses a method and system that may be used by an owner of an on-hold system to sell advertising space on the on-hold system to third parties.

Furthermore, more sophisticated on-hold system players have been developed. One such player is illustrated in U.S. Pat. No. 5,912,958 to Eyran et al. The player of the Eyran et al. '958 patent is digital and permits digital downloading of programs from a server over a communication link to the on-hold player so that convenient and clear means for distributing new messages is provided.

Sophisticated on-hold system equipment is costly, however, which could pose a problem for many community and non-profit organizations who have tight budgets. In addition, such organizations may lack personnel with the expertise to create programming and load it into the on-hold system player. This creates a problem not only during the initial loading of the player but also when updates are necessary. The prior art has not addressed these problems. In addition, the prior art has failed to disclose a way that a community or non-profit organization can use on-hold time to raise money for the organization while also providing information about the organization.

Accordingly, it is an object of the present invention to provide an on-hold sponsorship and advertising system and method whereby an organization is provided with on-hold equipment.

It is another object of the present invention to provide an on-hold sponsorship and advertising system and method whereby an organization is provided with program creation and program update services for the organization's on-hold system.

It is another object of the present invention to provide an on-hold sponsorship and advertising system and method whereby money is raised for an organization using the organization's on-hold system.

It is still another object of the present invention to provide an on-hold sponsorship and advertising system and method whereby an organization's activities are advertised to callers placed on hold.

It is still another object of the present invention to provide 3^{rd} party businesses with a cost effective means of advertising.

These and other objects and advantages will be apparent from the following specification.

### SUMMARY OF THE INVENTION

The present invention is directed to an on-hold sponsorship and advertising system and method. A service provider supplies a message player that is connected to an organization telephone system. The organization may be a community or non-profit organization such as a school, chamber of commerce, better business bureau or trade association. Messages containing organization information and advertisements for a business/sponsor are loaded on the message player by the service provider. As a result, callers who call the organization telephone system hear the messages when they are placed on hold. The message player preferably is digital so that a service provider computer server may provide message updates remotely to the message player.

In addition to providing the organization with the on-hold equipment, including the message player, the service provider sells advertising space on the on-hold equipment to business/sponsors. The service provider then loads messages featuring organization information and advertisements for the business onto the on-hold equipment. The service provider receives advertising fees from the business in exchange for the advertisements and distributes a portion of the advertising fees to the organization. The organization may also sell advertising space on the on-hold equipment directly to business/sponsors and receive a greater portion of the advertising fees.

The following detailed description of embodiments of the invention, taken in conjunction with the appended claims and accompanying drawings, provide a more complete understanding of the nature and scope of the invention.

### BRIEF DESCRIPTION OF THE DRAWINGS

FIG. 1 is a block diagram of an embodiment of the system of present invention;

FIG. 2 is a block diagram of an embodiment of the method of the present invention.

### DESCRIPTION OF THE PREFERRED EMBODIMENTS

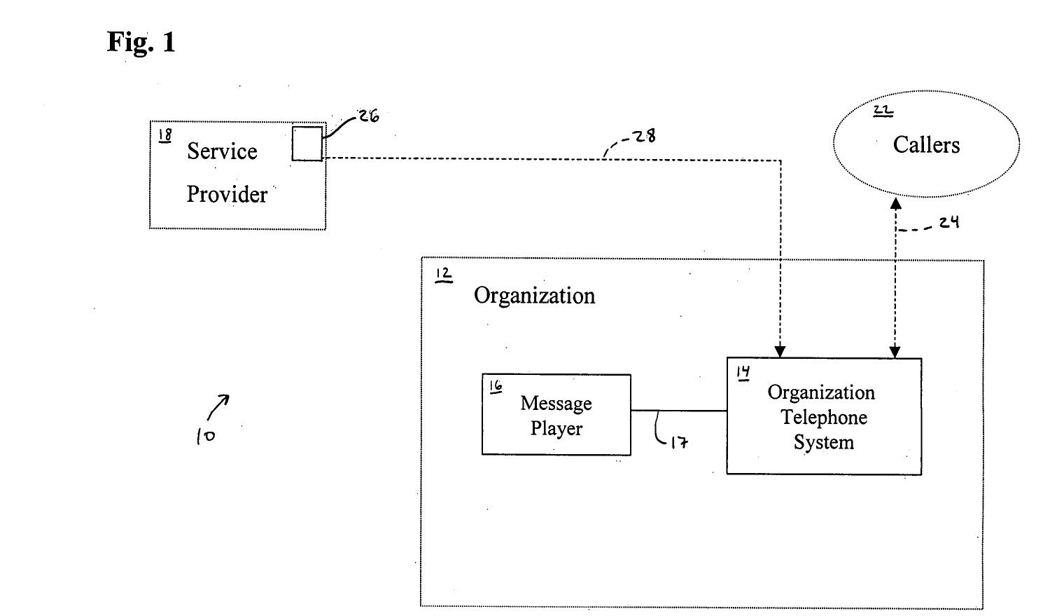

An embodiment of the system of the present invention is indicated in general at 10 in FIG. 1 as a block diagram. An organization 12 features a telephone system 14. The organization may be a business or a community or non-profit organization such as a school, church, chamber of commerce, better business bureau, trade association, etc. The organization telephone system may be any type of business or organization telephone system having on-hold capabilities, including a private branch exchange (PBX) system or simpler system.

A message player 16, also located at the office of the organization, is connected to the organization telephone system 14 via the system's MOH input as indicated by line 17. As will be explained below, the message player is preferably provided to the organization by a service provider 18. The player 16 may be virtually any on-hold player known in the art. The player is preferably, however, a digital player such as the model RUF2700 player from Premier Technologies, Inc. of Pittsburgh, Pa., or an MP3 player such as the model PD-312 from Prodigital Manufacturing, LLC, of Lincoln Park, Mich. A standard CD player and appropriate audio amplifier, such as the 1-watt model no. 1701 amplifier available from University Sound Inc. of Sylmar, Calif., could also be used as player 16.

Callers 22 calling the organization, as indicated by line 24, may be placed on hold. When this occurs, the player 16 plays messages to the caller including organization information such as the activities, schedule, events or services of the organization. In addition, the caller hears advertisements from the sponsors of the messages. More specifically, the organization information is presented to the caller through the sponsorship of 3^{rd} party businesses or other advertisers.

The messages loaded and played on player 16 are preferably created by service provider 18. An example of a message heard by a caller where the organization is a school is as follows:
“Come to the ______ High School football game this Friday night at ______ Field, kickoff is at 5:00 pm. This message is brought to you by your friends at ______ (name of business/advertiser), stop by and see us before the game.”
   As another example, if the organization were a chamber of commerce, the message played could include organization information promoting and marketing the community. As another example, if the organization were a better business bureau, the message played could include organization information promoting and marketing the services of the better business bureau. In both examples, the caller would also hear one or more advertisements from the sponsor(s) of the messages. A program of messages that is loaded into the player 16 could be, for example, around twelve minutes long.

In addition to providing the message player 16 (and associated equipment, if any) and the initial messages loaded thereon, the service provider 18 preferably also periodically provides updated message programs for the player. For example, the service provider may provide updates monthly so that twelve updates are performed per year.

How updates are accomplished depends upon the type of player being used. If the message player 16 is a tape or CD unit, the service provider may mail tapes or CDs containing the new messages to the organization 12 for insertion or loading into the message player. If a digital player is used, however, the service provider 18 may provide updates remotely. More specifically, the service provider has a computer server 26 into which the service provider enters updated messages in a digital file format. These updates are then downloaded from the service provider server 26 into the digital player 16 via a telephone, fax or data line, as indicated by line 28. Alternatively, if an MP3 player is used, the updates may be e-mailed from the service provider to the organization for loading into the player. The MP3 updated message files could also be mailed from the service provider 18 to the organization 12 on a standard 3.5 inch diskette for loading by the organization into the player.

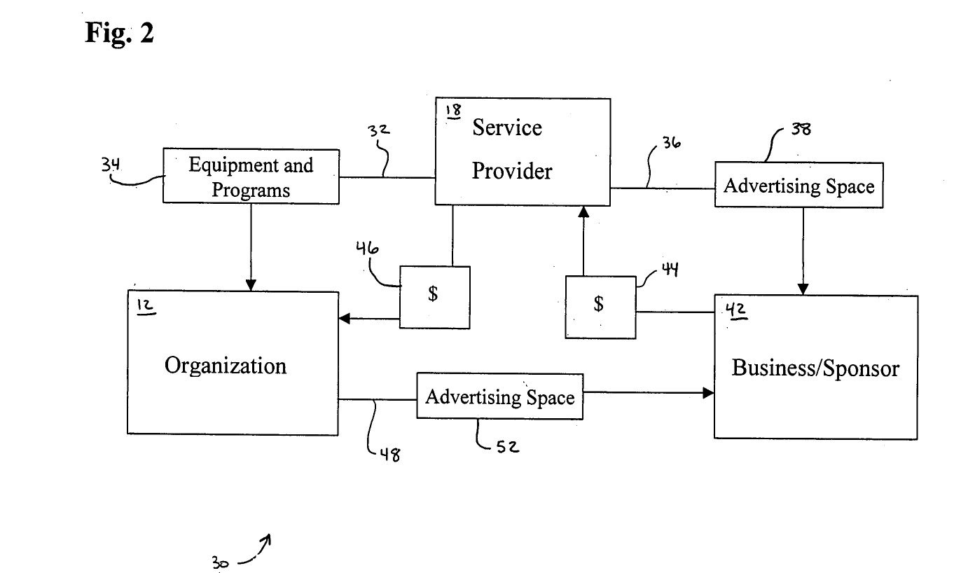

An embodiment of the method of the present invention, corresponding to the system of FIG. 1, is indicated in general at 30 in FIG. 2 in block diagram form. As indicated by line 32, and mentioned above, the service provider 18 provides to the organization 12 equipment and program recordings 34, including the message player 16 of FIG. 1. The service provider may install the equipment and programs at the office of the organization using its own personnel or it may alternatively ship the equipment to the organization. As explained with regard to FIG. 1, callers who then call the organization 12, and are placed on hold, hear organization information and advertisements from 3^{rd} party business sponsors. In the preferred embodiment of the invention, the organization is charged no fees for the equipment, its installation and the creation of the programs that are loaded on the equipment initially and as updates.

As indicated by line 36, the service provider sells advertising space 38 on the on-hold equipment 34 installed at the organization to a 3^{rd} party business or sponsor 42. Once sponsorships are obtained, the service provider may create the organization information and advertisement messages described above with regard to FIG. 1 and load them onto the equipment 34.

In exchange for the advertising space 38 on equipment 34, the business/sponsor 42 pays to the service provider fees 44. The service provider takes the cost of providing the equipment and programs 34, as well as a profit, out of the fees and the remainder 46 is provided to the organization 12. As a result, the organization receives both the benefits of an on-hold system providing callers with organization information and finds to support its activities. Fees 44 may be collected by the service provider from businesses/sponsors 42 on a yearly or monthly basis or alternative fee arrangements may be agreed upon. As an alternative to the service provider 18 collecting the advertising fees from the business/sponsor 42, the organization 12 could collect the advertising fees from the business/sponsor 42 and distribute a portion of the fees to the service provider.

As indicated by line 48, the organization may optionally sell advertising space 52 on the equipment 34 directly to a 3^{rd} party business/sponsor 42. In such instances, the organization could have an arrangement with the service provider to receive a greater percentage of the advertising fees 44 paid by the business/sponsor. For example, 25% of the advertising fees 44 paid by the business/sponsor 42 could be paid by the service provider 18 to the organization 12 if the service provider sells the on-hold advertising space 38 to the business/sponsor and 50% of the advertising fees paid by the business/sponsor could be paid to the organization by the service provider if the organization sells the on-hold advertising space 52 to the business/sponsor directly.

While the embodiment of the invention described above features a service provider, it is within the scope of the present invention to omit the service provider 18 completely and for the organization to sell advertising space directly to the business/sponsor, and receive the advertising fees directly from the business/sponsor.

The system and method of the present invention therefore provides to an organization free of cost an on-hold system that provides organization information to callers who are placed on hold. In addition, the system and method of the present invention acts as a means of fund-raising for the organization. The system and method of the present invention also provides 3^{rd} party businesses with a cost-effective way of advertising.

While the preferred embodiments of the invention have been shown and described, it will be apparent to those skilled in the art that changes and modifications may be made therein without departing from the spirit of the invention, the scope of which is defined by the appended claims.

1. A method for providing an on-hold service for an organization comprising the steps of:
a) providing the organization with on-hold equipment;
b) selling advertising space on the on-hold equipment to a business;
c) loading messages featuring organization information and advertisements for the business onto the on-hold equipment;
d) receiving advertising fees from the business in exchange for the advertisements; and
e) distributing a portion of the advertising fees to the organization.

2. The method of claim 1 further comprising the step of providing message updates for the on-hold equipment.

3. The method of claim 2 wherein the updates are provided remotely.

4. The method of claim 1 wherein steps a)-e) are performed by a service provider.

5. The method of claim 4 wherein step b) is also performed by the organization.

6. The method of claim 1 wherein the on-hold equipment includes a message player.

7. The method of claim 6 wherein the message player is a digital player.

8. The method of claim 6 wherein the message player is attached to a music on-hold input of an organization telephone system.

9. The method of claim 1 wherein the organization is a community organization.

10. The method of claim 1 wherein the organization is a non-profit organization.

11. The method of claim 1 wherein the organization is a school.

12. The method of claim 1 wherein the organization is a chamber of commerce.

13. The method of claim 1 wherein the organization is a better business bureau.

14. An on-hold system for an organization including:
a) an organization telephone system;
b) a message player connected to the organization telephone system;
c) messages containing organization information and advertisements for a 3^{rd} party business loaded on the message player;
whereby callers who call the organization telephone system hear the messages when they are placed on hold.

15. The system of claim 14 wherein the message player is digital.

16. The system of claim 15 further comprising a service provider computer server selectively in communication with the player so that the player may receive message updates remotely from the server.

17. The system of claim 14 wherein the message player is connected to the organization telephone system via a music on-hold input.

18. A method for an organization to raise funds and provide organization information to callers on hold via an on-hold system comprising the steps of:
a) selling advertising space on the on-hold system to a business;
b) loading messages featuring organization information and advertisements for the business on the on-hold system; and
c) receiving advertising fees from the business in exchange for the advertisements.

19. The method of claim 18 wherein steps a)-c) are performed by a service provider.

20. The method of claim 19 wherein step a) is also performed by the organization.
